(19) United States
(12) Patent Application Publication
(10) Pub. No.: US 2016/0152421 A1
(43) Pub. Date: Jun. 2, 2016

(54) SYSTEM AND METHOD FOR LOADING AND UNLOADING MATERIAL IN BULK FORM

(71) Applicant: Binod Kumar Bawri, Mumbai (IN)

(72) Inventor: Binod Kumar Bawri, Mumbai (IN)

(21) Appl. No.: 14/945,015

(22) Filed: Nov. 18, 2015

(30) Foreign Application Priority Data
Nov. 28, 2014 (IN) 3807/MUM/2014

(51) Int. Cl. B65G 65/32; B65G 67/20; B65G 67/24; B65G 65/38

(52) U.S. Cl. CPC B65G 65/32; B65G 65/38; B65G 67/20; B65G 67/24

(57) ABSTRACT

The present invention discloses a method and system for loading and unloading pulverized/fine grounded material. The system and method comprises articulately adjustable conveyor [AAC] and material handling container. The articulately adjustable conveyor [AAC] further comprises integrated collector bin [ICB], screw conveyor [SC] and standalone power supply [SPS]. The material handling container comprises foldable liner bag [FLB] and integrated shape bag [ISB]. During loading the method and system comprises receiving pulverized/fine grounded material to integrated collector bin [ICB] from carrier vehicle [CV] and conveys it to FLB through screw conveyor [SC]. And during unloading, ACC conveys the material from FLB to carrier vehicle [CV] through [AAC]'s through screw conveyor [SC].

### CROSS-REFERENCE TO RELATED APPLICATIONS

This application claims the benefit of priority to Indian Patent Application No. 3807/MUM/2014, filed on Nov. 28, 2014, the disclosure of which is hereby expressly incorporated by reference in its entirety.

### FIELD OF THE INVENTION

The present invention relates to the field of material handling process and equipment and more particularly, loading and unloading pulverized or fine grounded material in bulk form. The present invention is very useful in loading and unloading pulverized material to and from a material handling container.

### BACKGROUND OF THE INVENTION

Material handling process and equipment requirement has always been a topic of concern in manufacturing sector. Material handling process should be planned as per the procedure prescribed and availability of equipment. Usually material handing process includes loading as well as unloading of materials which could be manual or machined.

Loading and unloading of materials is considered as an unproductive step but also unavoidable. Loading and unloading of materials requires time, man power, machine and land/space. Hence, loading and unloading of material manually or by machine leaves us with demerits like labour cost, time consuming, material wastage due to lack of accuracy, etc. Since the material handling process does not contribute productive to the manufacturing sector, all the efforts have always been made to conserve the resources regarding loading and unloading process.

The loading and unloading of pulverized material is a very cumbersome process and the equipment requirement is also very specific. There are several material handling systems and methods which provide the facility of loading and unloading of pulverized material. For loading and unloading of pulverized material there are various solutions such as pressurized systems, or gravity systems. Also there is an alternative solution which includes packing pulverized or fine grounded material in bags, such as fifty kilogram bags, and then moving it from one place to another.

The systems and methods as stated herein above also have some drawbacks which hinder the smooth loading and unloading of pulverized material. The pressurized system includes suction and discharge pumps. These suction and discharge pumps lack in terms of cost, efficiency, time and human intervention. On the other hand, the gravity based system lacks in term of complexity in inclining container or wagon without assuring complete evacuation of container or wagon. The packing of material in bags have several drawbacks like intense labor, extra cost for labor work, increases truck holding time, non-reusable bags, chance of getting looted in remote areas, and the like. All the above described processes are found to be very tedious and complex, and thus require human intervention.

Accordingly, there is a need to constantly develop systems and methods for loading fine grounded material in bulk from a production site, inventory site and the like, to the material handling container and unloading fine grounded material in bulk from material handling container to the production site, inventory site and the like. Further, there is need of such systems and methods which can load as well as unload material with same efficiency. Furthermore, there is need of such methods and systems which can load and unload any kind of pulverized or fine grounded material. In this way, the user is enabled to load and unload pulverized or fine grounded material, thereby reducing the operation time and provides smooth process of material handling.

Therefore, an object of the present invention is to develop systems and methods for loading and unloading fine grounded material in bulk from a production site, inventory site and the like, to the material handling container and unloading fine grounded material in bulk from material handling container to the production site, inventory site and the like.

Yet another object of the present invention is to provide same efficiency during loading process as well as during unloading process.

Yet another object of the present invention is to provide complete evacuation of the material during loading and unloading process.

Yet another object of the present invention is to eliminate the loss of the material during loading and unloading process.

Yet another object of the present invention is to develop systems and methods which can load and unload any kind of pulverized/fine grounded material.

Yet another object of the present invention is to provide methods and systems which take less operation time for loading and unloading of pulverized or fine grounded material.

Yet another object of the present invention is to provide easy installation of the loading and unloading equipment.

Yet another object of the present invention is to provide safe and secure loading as well as unloading of pulverized or fine grounded material during any weather condition.

Yet another object of the present invention is to provide systems and methods for loading and unloading of pulverized or fine grounded material in any geographical condition.

These and other objects and advantages of the invention will be clear from the ensuing description.

### SUMMARY

In light of the above objects, a system and method is proposed for loading and unloading pulverized or fine ground material in bulk form transportable in closed and open material handling container.

The present invention provides solution to the above problems by presenting a system and method for loading and unloading pulverized or fine ground material in bulk form, to and from material handling container. The present system includes at least one liner bag, an adjustable conveyor mechanism, a hydraulic pump, an air compressor, and a power supply unit. The liner bag comprises a material holding compartment and an air holding compartment placed under the material holding compartment.

The adjustable conveyor mechanism is in operational communication with the liner bag. The adjustable conveyor mechanism is adapted to facilitate material loading as well as material unloading in a closed space and thus avoids wastage of fine grounded material. The hydraulic pump is in operational communication with the adjustable conveyor mechanism. The hydraulic pump is adapted to lift the adjustable conveyor mechanism as per the loading and unloading conditions.

The air compressor is connected to the air holding compartment. The air compressor is adapted to provide the pressurized air to the air holding compartment. While material unloading, the air holding compartment is uplifted due to the pressurized air and a slope is created to facilitate the complete evacuation of the material. The power supply unit is adapted to provide power to adjustable conveyor mechanism, hydraulic pump, and the air compressor. The liner bag and the adjustable conveyor mechanism of the present system are arranged to form a single conduit and thus protects the loss of material during loading and unloading process.

The present invention further provides a material handling process having a material loading step and a material unloading step. The material loading step further includes a step of deflating the air holding compartment by connecting the at least one air compressor with a pressure relive valve of the air holding compartment. In the next step the material is poured into at least one collector bin connected with at least one adjustable conveyor mechanism. In the next step, the said poured material is transferred through the said at least one adjustable conveyor mechanism. Finally, the material is dispensed to the material holding compartment of the liner bag, wherein the material holding compartment is in an open position to hold the material inside thereof.

The material unloading step further includes a step of inflating the air holding compartment through an air pressure applied by connecting the at least one air compressor with an air filing port of the air holding compartment. This inflating of the air holding compartment is adapted to provide a substantial slope inside the liner bag and thereby allowing the material to drain from the liner bag through the substantial slope towards the screw conveyor mechanism. In the next step, a base of the material handling compartment is the uplifted by the said inflating of the air holding compartment. In the next step the material from the liner bag to the adjustable conveyor mechanism is transferred. Finally, the material is disposed to a desired location with the help of the screw conveyor mechanism.

These aspects of the present invention, along with the various features of novelty that characterize the present invention, are pointed in the below description. For a better understanding of the present invention, its operating advantages, and the specific objects attained by its uses, reference should be made to the accompanying drawing and descriptive matter in which there is illustrated an exemplary embodiment of the present invention.

### DESCRIPTION OF THE DRAWINGS

The advantages and features of the present invention will become better understood with reference to the following detailed description taken in conjunction with the accompanying drawings, in which:

FIG. 1 illustrates a block diagram of a system 100 for loading and unloading of pulverized materials, according to various embodiments of the present invention;

FIG. 2 illustrates a diagram which shows the mechanical layout of the system 100 during loading process, according to various embodiments of the present invention;

FIG. 3 illustrates a flow diagram 300 which shows the basic operational procedure for loading process, according to various embodiments of the present invention;

FIG. 4 illustrates a diagram 400 which shows the mechanical layout of system 100 during unloading process, according to various embodiments of the present invention;

FIG. 5 illustrates a flow diagram 500 which shows the basic operational procedure for unloading process, according to various embodiments of the present invention; and

FIG. 6 illustrates a diagram which shows the operation of the liner bag or the material handling bag (106) in conjugation with the foldable material holding compartment and air holding compartment, according to various embodiments of the present invention.

Like reference numerals refer to like parts throughout the description of several views of the drawing.

### DESCRIPTION OF THE INVENTION

The exemplary embodiments described herein detail for illustrative purposes are subject to many variations in implementation. It should be emphasized, however, that the present invention is not limited to a method and system for loading and unloading pulverized or fine grounded material in bulk, to and from material handling container. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The pulverized or fine grounded material does not limited to the size of particles of the material.

The present invention provides system and method for loading and unloading pulverized/fine ground material in bulk form which can be transported from one place to another place. The term pulverized/fine ground material as mentioned herein refer to materials which are in the form of grains and powders. The pulverized/fine ground material can be a natural occurring substance or a substance produced by the process of grinding and crushing. Suitable examples of pulverized/fine ground material include, but are not limited to, cement, gunpowder, fine snow, household dust, volcanic ash, sand, mineral powder, ores, food grains, pulses, spices and the like.

The system of the present invention includes at least one liner bag, an adjustable conveyor mechanism, a hydraulic pump, an air compressor, and a power supply unit. The liner bag includes a material holding compartment and an air holding compartment, wherein, the air holding compartment is situated under the material holding compartment.

The material holding compartment of the liner bag is a foldable liner bag [FLB] and the air holding compartment of the liner bag is an integrated shape bag or inflatable space bag [ISB]. The liner bag of the present system further includes at least one bag holding mechanism such as a hook, a holder, a chain, and a Velcro. The bag holding mechanism is adapted to hold the said liner bag in an open state.

The at least one inflatable space bag [ISB] includes at least one air filling port and at least one pressure relief valve. The at least one inflatable space bag [ISB] is adapted to be filled with air, gas, fluid, or any other space lifting material through the air filling port. Accordingly, the at least one foldable liner bag and at least one inflatable space bag [ISB] are capable for altering the space inside the liner bag.

During material loading step, the air compressor is connected to the air holding compartment via a pressure relive valve for evacuating the air trapped inside the at least one air holding compartment. During material loading step, the at least one air compressor is connected to the at least one air holding compartment via an air filing port for air inflation in the at least one air holding compartment.

The adjustable conveyor mechanism as disclosed herein is an articulately adjustable conveyor [AAC]. The articulately adjustable conveyor [AAC] further includes an integrated collector bin [ICB] and a screw conveyor [SC] connected with each other. Specifically, the adjustable conveyor mechanism includes a plurality of adjustable screw conveyors connected with each other through a junction box, wherein the junction box is further connected with at least one collector bin.

The at least one collector bin as provided herein includes a recess opening adapted for receiving the material during the loading process. The plurality of adjustable screw conveyor are connected with at least one liner bag through a coupling medium present on the at least one liner bag. Further, the plurality of adjustable screw conveyor are adapted to connect the at least one liner bag with an external environment. The external environment is at least one of a material loading environment, or a material unloading environment such as a standalone carrier vehicle [CV].

The standalone carrier vehicle [CV] brings the pulverized or fine ground material to be transported by a material handling container and similarly the carrier vehicle [CV] take it from material handling container to the disposal point.

The hydraulic pump is in operational communication with the adjustable conveyor mechanism. The hydraulic pump is adapted to lift the adjustable conveyor mechanism as per the loading and unloading conditions. The power supply unit is adapted to provide power to adjustable conveyor mechanism, hydraulic pump, and the air compressor. The liner bag, the adjustable conveyor mechanism and the carrier vehicle of the present system are arranged to form a single conduit and thus protects the loss of material during loading and unloading process.

The present invention further provides a material handling process having a material loading step and a material unloading step. The material loading step further included a step of deflating the air holding compartment by connecting the at least one air compressor with a pressure relive valve of the air holding compartment. In the next step, the material is poured into at least one collector bin connected with at least one adjustable conveyor mechanism. In the next step, the said poured material is transferred through the said at least one adjustable conveyor mechanism. Finally, the material is dispensed to the material holding compartment of the liner bag, wherein the material holding compartment is in an open position to hold the material inside thereof.

During material loading step, the integrated collector bin [ICB] collects the pulverized or fine ground material from the carrier vehicles [CVs]. The pulverized or fine ground material is then transferred to foldable liner bag [FLB] through a screw conveyor [SC]. The screw conveyor [SC] is installed between integrated collector bin [ICB] and foldable liner bag [FLB].

The material unloading step further includes a step of inflating the air holding compartment through an air pressure applied by connecting the at least one air compressor with an air filing port of the air holding compartment. This inflating of the air holding compartment is adapted to provide a substantial slope inside the liner bag and thereby allowing the material to drain from the liner bag through the substantial slope towards the screw conveyor mechanism. In the next step, a base of the material handling compartment is the uplifted by the said inflating of the air holding compartment. In the next step the material from the liner bag to the adjustable conveyor mechanism is transferred. Finally, the material is disposed to a desired location with the help of the screw conveyor mechanism.

During material unloading step, the pulverized or fine ground material as present in the foldable liner bag [FLB] is lifted and drained out due to the substantial slope formation. The pulverized or fine ground material is then transferred directly to the carrier vehicle [CV] through screw conveyors [SCs].

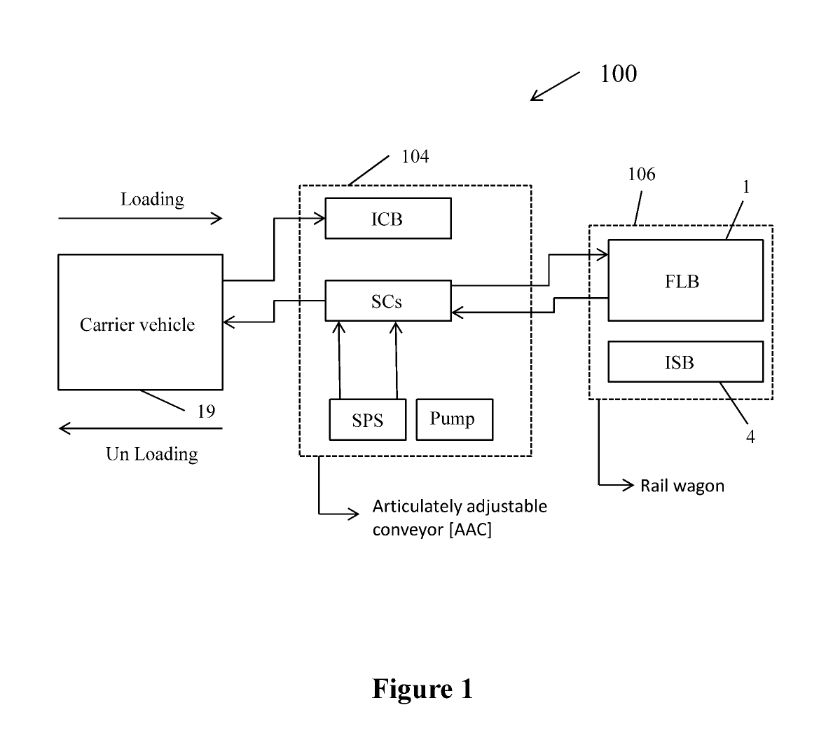

Now, referring to FIG. 1, which provides a block diagram for the system and method of loading and unloading the material. In this diagram the system and method of loading and unloading the material has been shown in a simplified way. In FIG. 1, the system 100 is structurally categorized into three parts, firstly, a carrier vehicle [CV] 19, secondly an articulately adjustable conveyor [AAC] mechanism 104 and thirdly a material handling container 106.

The first part is the carrier vehicle [CV] 19. The carrier vehicle 19 could be any material transporting machine, for example truck, bull dozer, and the like. Carrier vehicle [CV] 19 is responsible for bringing materials that is to be loaded, and carrying away unloaded material in case of unloading.

The second part, the articulately adjustable conveyor [AAC] 104, includes three parts in it, namely integrated collector bin [ICB], screw conveyor [SC] and standalone power supply [SPS] with hydraulic pumps coupled to the [SPS].

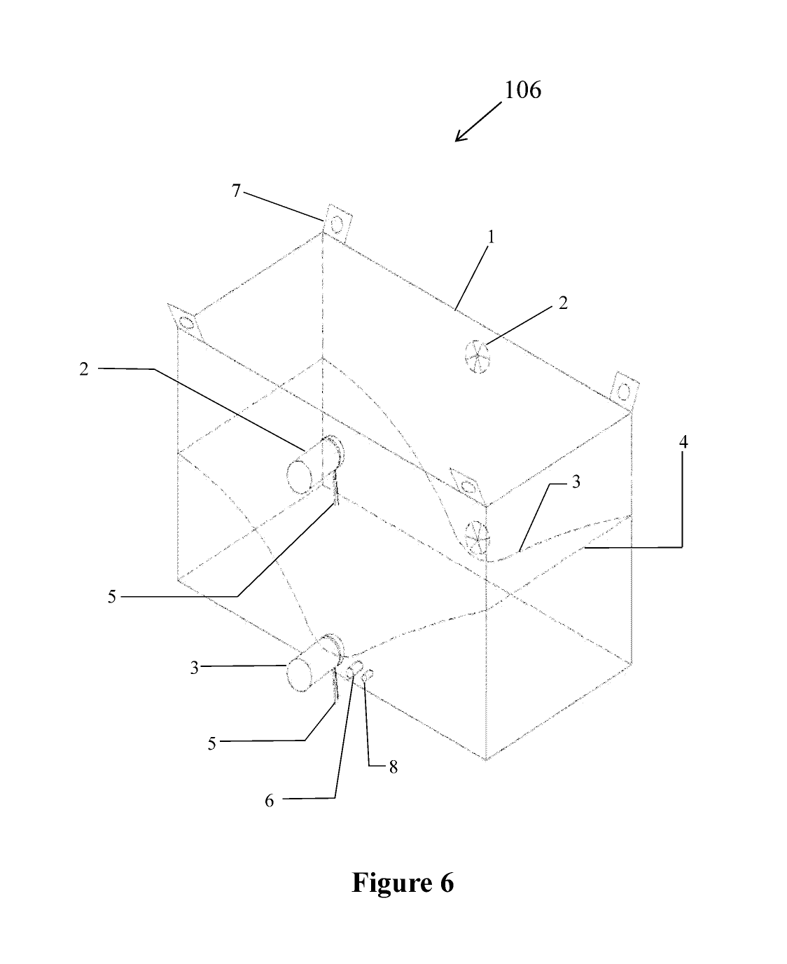

The last part is the material handling container 106, which includes foldable liner bag [FLB] and integrated shape bag [ISB]. In one embodiment, the [FLB] and the [ISB] are shown with reference to FIG. 6 and explained in details later in the description.

Now, referring to FIG. 1 there is also shown how the material flows in all the three parts at the time of loading and unloading. In case of loading, the material is handed over to integrated collector bin [ICB] by the carrier vehicle [CV] 102. Then from integrated collector bin [ICB], the screw conveyor [SC] conveys the material to the foldable liner bag [FLB] as present inside the material handling container 106.

In case of unloading, the material is taken out from foldable liner bag [FLB] through the screw conveyor [SC] and finally the screw conveyor [SC] disposes the material in the carrier vehicle [CV] 19. The difference between the process of loading and unloading is that while unloading, the screw conveyor [SC] disposes the material directly into the carrier vehicle [CV] 19, without using the integrated collector bin [ICB] in-between.

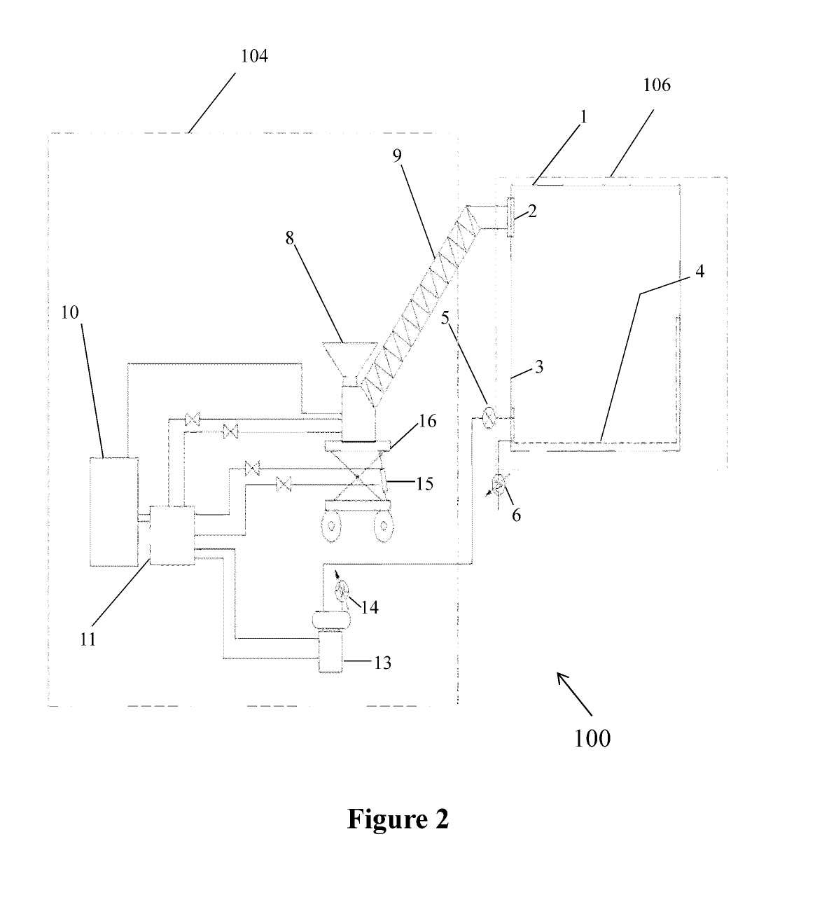

Now referring to FIG. 2, there is shown a mechanical layout of the system 100 during loading of pulverized/granular material. In this process, the foldable liner bag [FLB] (1) is already unfolded and installed in the material handling container 106. The articulately adjustable conveyor [AAC] (16) is brought to the best suited position on ground to convey the material from the Carrier Vehicle [CV] 19 to the loading port (2) of the foldable liner bag [FLB] (1).

Simultaneously, the output end of a loading Screw Conveyor (9) is raised to the level, position and orientation of the loading port (2) of the foldable liner bag [FLB] (1) by means of a Hydraulic Actuator (15).

In one embodiment, the loading port (2) of foldable liner bag [FLB] (1) is connected by coupling means to the output end of the loading screw conveyor (9) of the articulately adjustable conveyor [AAC] (16).

Power is supplied to the screw conveyor (9) by means of a standalone power supply [SPS] (10). For the hydraulic actuator (15), power is transformed from the standalone power supply [SPS] (10) to a hydraulic pump (11). Power in pneumatic form from an air compressor/pump (13) is used to evacuate any air trapped in the integrated shape bag [ISB] (4) for complete deflation.

The air hose of the articulately adjustable conveyor [AAC] 14 connects the air compressor (13) to the air filling port (3) of the integrated shape bag [ISB] (4).

During loading, the air compressor (13) is started and this leads to the complete succession of the air trapped inside the integrated shape bag [ISB] (4). Same air compressor (13) with pressure gauge (14) and pressure relief valve (6) is used during unloading operation by filling the air inside the integrated shape bag [ISB] (4).

Further, the pulverized/granular material is being disposed from the carrier vehicle (19) into the integrated collector bin and junction box (8). Then the material is simultaneously being transported by the screw Conveyor (9) to the foldable liner bag [FLB] (1).

This process of conveying the fine ground material from the Carrier vehicle (19) is continued till foldable liner bag [FLB] (1) gets fully filled or till the material inside Carrier vehicle (19) is completely disposed. The process is also repeated for two material handling bags kept per material handling container and for all material handling containers. Depending on loading and unloading time window kept by an authority, the number of the articulately adjustable conveyors [AACs] (16) can be used accordingly.

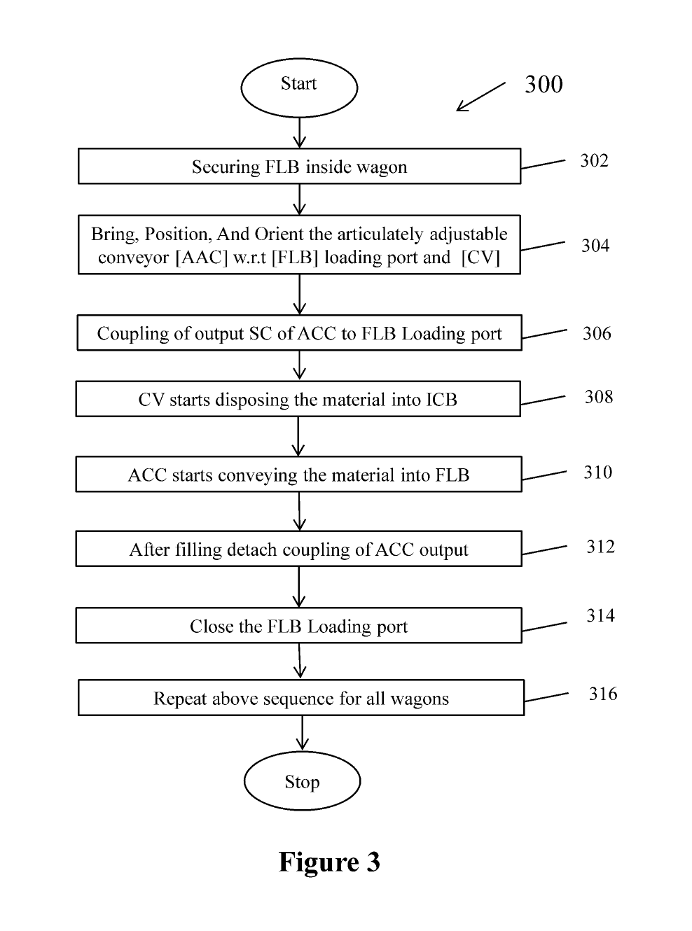

Now referring to FIG. 3, there is shown the basic operational procedure for loading. The method 300 initiates at step 302 where the user secures foldable liner bag [FLB] (1) inside the material handling container. Further at next step 304, the user brings, positions, and orients the articulately adjustable conveyor [AAC] 16 with respect to the loading port (2) of the foldable liner bag [FLB] (1) as well as with the position of the carrier vehicle [CV] (19).

Further, at next step 306, the user couples the output port of the screw conveyor [SC] (19) with the loading port (2) of foldable liner bag [FLB] (1). At the next step 308, the material is disposed into the integrated collector bin [ICB] (8). Further at step 310, the articulately adjustable conveyor [AAC] (16) conveys the material into foldable liner bag [FLB] (1). When, the foldable liner bag [FLB] (1) is completely filled, then, the method 300 flows to step 312.

At step 312, the user detaches the coupling of the articulately adjustable conveyor [AAC] (16) output port from the loading port (2) of the foldable liner bag [FLB] (1). Further at step 314 of method 300, the user closes the loading port (2) of the foldable liner bag [FLB] (1). At last step 316, the above steps gets repeated for required number of times and then method 300 terminates after finishing the complete loading of the material available.

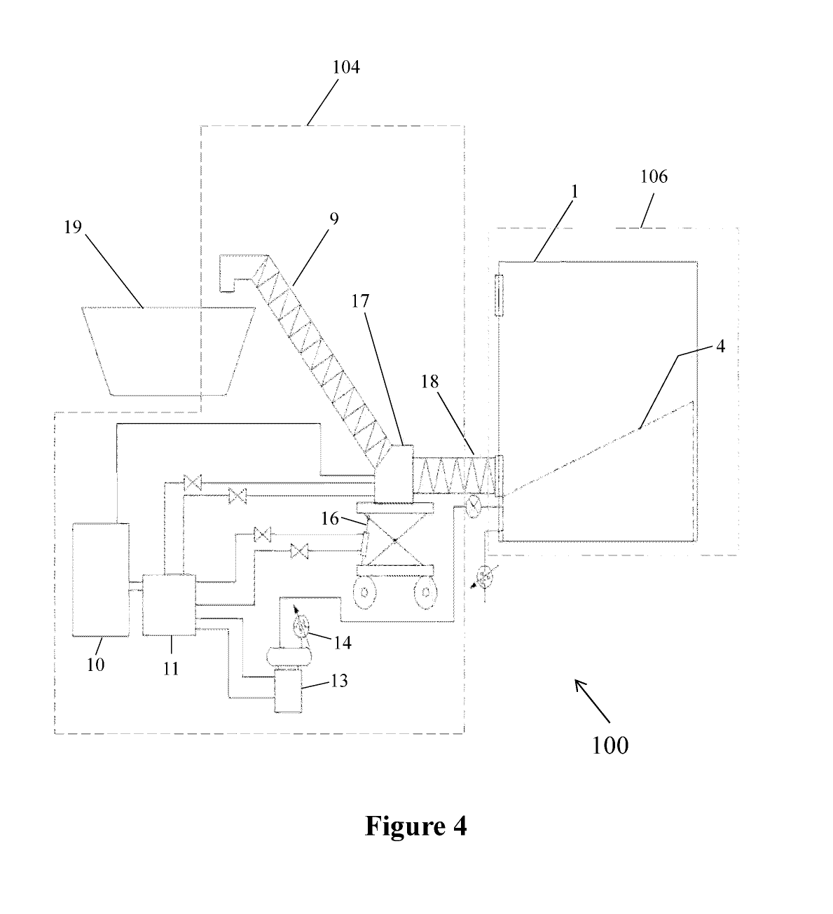

Now referring to FIG. 4, there is shown the mechanical layout of the system 100 during unloading of pulverized/granular material. While all the components of the articulately adjustable conveyor [AAC] (16) remain same as described in FIG. 2, the screw conveyors are articulately adjusted with the unloading port of the foldable liner bag [FLB] (1) as shown in this FIGS. 4 and 6.

The input port of the screw conveyor (18) is coupled with the unloading port (3) of the foldable liner bag [FLB] (1). This coupling means provides a leak proof mechanism for unloading the material from the foldable liner bag [FLB] (1). The screw conveyor (9) is adjusted in accordance to the position of the carrier vehicle (19). Power is supplied to the screw conveyors (9 and 18). The material is transferred from the foldable liner bag [FLB] (1) to the carrier vehicle (19) via a junction Box (17).

Once the fine ground material present inside the foldable liner bag [FLB] (1) reaches to the sufficient level of the screw conveyor input end, simultaneously, the integrated shape bag [ISB] (4) is inflated by the air compressor (13). The integrated shape bag [ISB] (4) takes its maximum shape and become like a sloppy structure. This sloppy structure forces the remainder material to reach in close vicinity of the screw conveyor (18) input end. Thus, complete evacuation of the remainder material takes place.

This process of conveying the fine ground material to the carrier vehicle is continued till foldable liner bag [FLB] (1) gets fully emptied or till the carrier vehicle (19) is completely filled with the material. And the process is also repeated for two material handling bags kept per material handling container and for all material handling container. Depending on loading and unloading time window kept by the authority, the number of the articulately adjustable conveyors [AACs] can be used accordingly.

Once the foldable liner bag [FLB] (1) is completely evacuated, the integrated shape bag [ISB] is deflated using same air compressor. The foldable liner bag [FLB] (1) is then removed from the magnetic hooks and folded flat. It is then removed from the material handling container and stored in storage bins for further use.

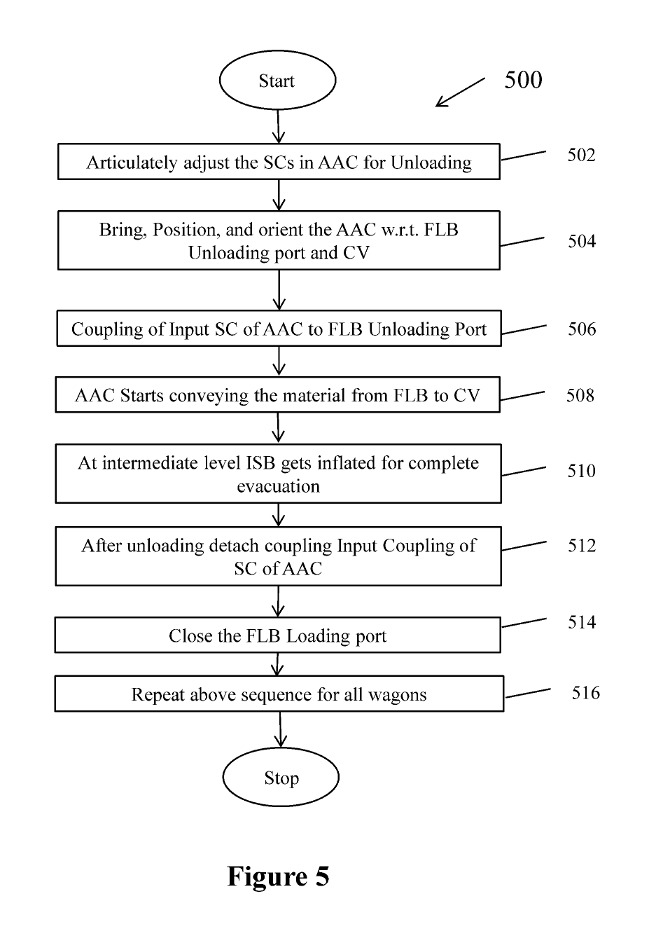

Now referring to FIG. 5, there is shown the basic operational procedure for unloading. The method 500 initiates at step 502, where the method 500 articulately adjusts the screw conveyors [SCs] (9, 18) of the articulately adjustable conveyor [AAC] 16 for unloading.

Further at step 504, the method 500 sets the position and orientation of the articulately adjustable conveyor [AAC] 16 with respect to the loading port (2) of the foldable liner bag [FLB] loading port (2) as well as the position of the carrier vehicle [CV] 19.

The method 300 then flows to step 506, where user couples the input port of the screw conveyor [SC] (18) with the unloading port (3) of the foldable liner bag [FLB] (1). At step 508, the integrated shape bag [ISB] gets inflated gradually with the help of air pressure and this leads to the complete evacuation of the material from the foldable liner bag [FLB] (1).

Further at step 510, the articulately adjustable conveyor [AAC] 16 starts conveying the material from the foldable liner bag [FLB] (1) to the carrier vehicle [CV] 19. After complete evacuation and complete unloading all the material from the foldable liner bag [FLB] (1), the method then flows to step 512. At step 512, the coupling of the input port of the screw conveyors [SCs] (18, 9) is detached from the unloading port (3) of the foldable liner bag [FLB] (1).

Further at step 514, the user closes the unloading port (3) of the foldable liner bag [FLB] (1). At last step 516, the above step gets repeated for required number of times and then method 500 terminates after finishing the complete unloading of the material available.

Now referring to FIG. 6, there is shown the basic structure, functionality and operation of the liner bag or the material handling bag (106). The material handling bag (106) disclosed herein can be of any shape. Preferably, the material handling bag (106) is a rectangular bag having four side walls connected with a top surface and bottom surface.

More specifically, the material handling bag (106) includes a central material compartment surrounded by an air compartment. The air compartment surrounds the central material compartment on its four side wall surfaces as well as the bottom surface. The central material compartment includes a bag structure which is termed as the foldable liner bag [FLB] (1).

The air compartment also includes a bag structure which is termed as an integrated shape bag [ISB] (4). The integrated shape bag [ISB] (4) is an inflatable compartmentalized bag. When the integrated shape bag [ISB] (4) is in deflated condition then the volume of foldable liner bag [FLB] (1) increases and thus provides maximum volume to load the fine ground material. The foldable liner bag (1) and the integrated shape bag (4) both are structured to form the material handling bag as one unit.

At least one of the side walls of the foldable liner bag includes a loading port (2) on the upper side thereof and an unloading port (3) on the lower side thereof. Preferably, the loading port (2) and unloading port (3) are integrated on the longer sidewalls of the foldable liner bag [FLB] (1). Both the ports are fitted with coupling means (5) which can be used to couple the output and input ends of the screw conveyors [SCs] (9) (18) with the loading and unloading port (3) (2). Moreover, the coupling means (5) provides the proper sealing of the screw conveyors [SCs] (9) (18) with the material handling bag and thus prevents leakage during loading and unloading process.

The foldable liner bag [FLB] (1) is made of multi layers liners to take care of strength and protection of material from moisture and water. It is a leak proof, tear proof, long life reusable bag. The foldable liner bag [FLB] (1) also consist of an integrated internal strengthen membrane that divides the foldable liner bag [FLB] (1) and forms integrated shape bag [ISB] (4). During loading condition, the screw conveyor (9) output end is attached to the loading port (2) present on the upper side of the foldable liner bag [FLB] (1), and, the material is transferred from the carrier vehicle (19) to the integrated collector bin [ICB] (8). Thereafter, the material is transferred from the integrated collector bin [ICB] (8) to the screw conveyor (9) and, finally material is filled inside the foldable liner bag [FLB] (1).

During unloading, the screw conveyor (18) input end is attached to the unloading port (3) present on the lower side of the foldable liner bag [FLB] (1) and the material starts to flow from the foldable liner bag [FLB] (1) to the screw conveyor [SCs] (18). When the level of material being evacuated reaches to level of unloading port (3), the integrated shape bag [ISB] (4) is simultaneously inflated by means of the pump/air compressor (13).

The air is provided to the air filling port (6) of the integrated shape bag [ISB] (4) with the help of a hose connected from articulately adjustable conveyor [AAC] (16). As the air is filled through the air filling port (6), the integrated shape bag [ISB] (4) acquires a chute like structure. The above air filling process brings all the remainder material in the close vicinity of screw conveyor for its evacuation.

A Pressure Relief Valve (8) is installed on the integrated shape bag [ISB] (4) thus maintains allowable pressure inside the integrated shape bag [ISB] (4). Moreover, the pressure relief valve (8) also provides safety to the integrated shape bag [ISB] (4).

The foldable liner bag [FLB] (1) is installed in the material handling container (106) by means of magnetic hook (7). These magnetic hooks will allow the bag to be opened up during loading and cling on to the walls to prevent any unnecessary folding of the bags while filling. In this manner, the integrated shape bag [ISB] (4) carries and evacuate whole of the material.

The present invention should not be construed to be limited to the configuration of the method and system as described herein only. Various configurations of the system are possible which shall also lie within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed:

1. An apparatus for loading and unloading material, the apparatus comprising:
at least one liner bag having at least one material holding compartment, and at least one air holding compartment placed under the said material holding compartment;
at least one adjustable conveyor mechanism in operational communication with the said liner bag, the said adjustable conveyor mechanism is adapted to facilitate material loading as well as material unloading in and from the said liner bag by adjusting the height of the conveyer mechanism during loading or unloading process;
at least one air compressor connected to the at least one air holding compartment, the said air compressor is adapted to inflate the said air holding compartment during loading of the said liner bag and deflate the said air holding compartment during unloading of the said liner bag; and
at least one power supply unit adapted to power the said adjustable conveyor mechanism, and the said air compressor.

2. The apparatus as claimed in claim 1, wherein the said liner bag comprises at least one bag holding mechanism, wherein the bag holding mechanism is adapted to hold the said liner bag in an open state in a carrier vehicle.

3. The apparatus as claimed in claim 2, wherein the bag holding mechanism is at least selected from one of a hook, a holder, a chain, or a Velcro.

4. The apparatus as claimed in claim 1, wherein the said adjustable conveyor mechanism is movable and adjustable through a hydraulic pump connected therewith.

5. The apparatus as claimed in claim 1, wherein the said adjustable conveyor mechanism comprises:
a plurality of adjustable screw conveyors connected with each other, wherein one end of the said plurality of adjustable screw conveyors are in communication with the said liner bag;
a junction box connected to the plurality of adjustable screw conveyors at other end; and
at least one collector bin having a recess opening adapted for receiving the material during the loading process, wherein the said collector bin is in communication with the plurality of adjustable screw conveyors via the junction box.

6. The apparatus as claimed in claim 1, wherein the said material holding compartment is a foldable liner bag and the said air holding compartment is an inflatable space bag.

7. The apparatus as claimed in claim 6, wherein the said inflatable space bag comprises at least one air filling port and at least one pressure relief valve, wherein the said air filling port provides an opening to fill the said inflatable space bag with air, gas, fluid, or any other space lifting material.

8. The apparatus as claimed in claim 6, wherein the said foldable liner bag and the said inflatable space bag are capable of altering the space inside of the said liner bag.

9. The apparatus as claimed in claim 7, wherein during material loading the said air holding compartment is connected with the air compressor via the pressure relief valve, wherein the said air compressor evacuates the air trapped inside from the said air holding compartment.

10. The apparatus as claimed in claim 7, wherein during material unloading the said air holding compartment is connected with the air compressor via an air filing port, and wherein the said air compressor fills air inside the said air holding compartment.

11. The apparatus as claimed in claim 1, wherein the at least one power supply unit is a standalone power supply unit or an integrated power supply unit.

12. A method for material handling, the method comprises:
a material loading process, wherein a material is loaded onto at least one liner bag having at least one material holding compartment, and at least one air holding compartment placed under the said material holding compartment; and
a material unloading process, wherein the said loaded material is unloaded from the said liner bag by inflating the said air holding compartment of the liner bag.

13. The method as claimed in claim 12, wherein the material loading process comprises, transferring the material into the said liner bag via at least one adjustable conveyor mechanism, wherein the said adjustable conveyor mechanism is in operational communication with the said liner bag.

14. The method as claimed in claim 13, wherein the material loading process comprises:
deflating the air holding compartment by connecting at least one air compressor with a pressure relief valve of the said air holding compartment;
adjusting the height of an adjustable conveyor mechanism;
pouring a material required to be loaded in a collector bin via a recess opening thereof, wherein the said collector bin is in communication with the adjustable conveyor mechanism via a junction box; and
transferring the material from the collector bin into the said material holding compartment via the said adjustable conveyor mechanism.

15. The method as claimed in claim 14, wherein the said adjustable conveyor mechanism is movable and adjustable using at least one hydraulic pump connected therewith.

16. The method as claimed in claim 14, wherein the at least one adjustable conveyor mechanism comprises a plurality of adjustable screw conveyors connected with each other through a junction box, wherein the junction box is further connected with at least one collector bin.

17. The method as claimed in claim 12, wherein the material unloading process comprises:
inflating the air holding compartment through an air pressure applied by connecting an air compressor with the air holding compartment via at least one pressure relief valve, wherein the air holding compartment when inflated is adapted to provide a substantial slope inside the liner bag for allowing the material to drain from the liner bag through the slope;
adjusting the height of the said adjustable conveyor mechanism; and
transferring the material from the liner bag to a carrier vehicle via the said adjustable conveyor mechanism which is in operational communication with the said liner bag.
